(19) United States
(12) Patent Application Publication
(10) Pub. No.: US 2002/0189262 A1
(43) Pub. Date: Dec. 19, 2002

(54) Method for operating a steam turbine , and a turbine system provided with a steam turbine that functions according to said method

(76) Inventors: Christoph Noelscher, Nuernberg (DE); Rudolf Thiele, Erlangen (DE)

Correspondence Address: HARNESS, DICKEY & PIERCE, P.L.C., P.O.BOX 8910, RESTON, VA, 20195, US

(21) Appl. No.: 10/168,483

(22) PCT Filed: Dec. 20, 2000
(86) PCT No.: PCT/DE00/04574

(30) Foreign Application Priority Data
Dec. 21, 1999 (DE) 19961761.9

(51) Int. Cl. F02C 6/18

(52) U.S. Cl. 60/772; 60/39.182

(57) ABSTRACT

The invention relates to a method for operating a steam turbine (5, 5′) in which steam supplied as fresh steam (FD) that is expanded in order to effect work. According to the invention, the fresh steam (FD) is generated in a gas turbine (2, 2′) by heating cool steam (KD) that is supplied thereto. To this end, the steam turbine (5, 5′) that is cooled with the water vapor (WD) is connected on the inlet side to the steam-cooled gas turbine (2, 2′) via a fresh steam line (6, 6′) through which the heated cool steam (KD) is supplied as fresh steam (FD) from the gas turbine (2, 2′) to the steam turbine (5, 5′).

The invention relates to a method for operating a steam turbine according to the preamble of claim 1. It relates, further, to a turbine plant with a steam turbine working according to said method.

With gas turbines used in hitherto existing power plants, a plant efficiency of up to approximately 40% can be achieved at the present time. The working medium for the gas turbine is generated by burning of a fuel, for example crude oil or natural gas, with compressed air being supplied. The working temperature or working medium temperature of the gas turbine is at the present time about 1200° C. to 1400° C. On account of this high temperature of the working medium, turbine parts of the gas turbine, in particular its guide vanes and moving blades and also the turbine shaft and/or the turbine casing, are normally cooled. The coolant used for this purpose may be part of the compressed air according to WO 97/23715 or a fuel mixture according to WO 98/48161.

By contrast, with steam turbines used hitherto, a plant efficiency of approximately 38% to 40% can be achieved with a fresh-steam temperature of approximately 540° C. To enhance the fresh-steam state with a desired fresh-steam temperature of 600° C. and a desired fresh-steam pressure of 270 bar and consequently to increase the efficiency of a steam turbine, there is provision according to WO 97/25521, to cool the turbine shaft and, in particular, the blade roots of specific moving blades by means of cooling steam. A steam-cooled steam turbine is also known from U.S. Pat. No. 2,451,261.

With a combined gas and steam turbine plant, in which the heat contained in the expanded working medium from the gas turbine is only limited, if only because of this low fresh-steam temperature in comparison with the initially mentioned desired fresh-steam temperature of 600° C. If the cooling steam were heated to a higher temperature than this maximum fresh-steam temperature capable of being achieved, the consequently higher working capacity or exergy of the heated cooling steam would not be utilized or would be utilized only insignificantly.

The object on which the invention is based is to specify a method for operating a steam turbine, in which an increase in the plant efficiency is achieved by the efficient utilization of the heat of the cooling steam heated in a gas turbine. Furthermore, a turbine plant with a steam turbine particularly suitable for carrying out the method is to be specified.

As regards the method, the object is achieved, according to the invention, by means of the features of claim 1. In this respect, the steam turbine is operated, virtually exclusively, by cooling steam which is heated in the gas turbine and which, for this purpose, is supplied as fresh steam to the expediently cooled steam turbine. Preferably, in this case, cooling steam is supplied directly to the gas turbine and is then heated or superheated in the gas turbine. However, cooling water may also be supplied to the gas turbine, which is then first evaporated and subsequently heated or superheated in the gas turbine.

In this case, the likewise steam-cooled steam turbine is operated with cooling steam heated to a temperature higher than 600° C. In a gas and steam turbine plant, this cooling steam serves as fresh steam for a separate steam turbine, that is to say one in addition to the steam turbine already present in the gas and steam turbine plant.

The invention, in this context, proceeds from the notion that, in a gas turbine cooled by steam, because of its high working-medium temperature of more than 1200° C. a steam temperature of the cooling steam heated in the gas turbine of more than 600° C. can be achieved. The gas turbine can thus work virtually as a steam generator and a steam superheater for generating fresh steam with a correspondingly high fresh-steam temperature. When a steam turbine is operated by means of this heated cooling steam from the steam-cooled gas turbine, the inlet-steam temperature or fresh-steam temperature of said steam turbine can be brought nearer to the high working-medium temperature of the gas turbine. As a result, on the one-hand, fresh steam with a temperature above the hitherto desired 600° C. can be generated in a particularly simple and effective way for a steam turbine, thus leading to a further increase in steam turbine efficiency. On the other hand, the working capacity or exergy of the cooling steam heated in the gas turbine to a temperature higher than or equal to 600° C. can be utilized more effectively than is possible with hitherto existing plant concepts. This, in turn, leads to an increase in plant efficiency.

By the suitable routing of the cooling steam within the gas turbine, it is virtually possible to heat the cooling steam to preferably 700° C. to 800° C. The resulting comparatively low cooling effect, as compared with a heating of the cooling steam to a lower temperature, within the gas turbine, as a consequence of the comparatively low temperature gradient, can be compensated by an increase in the cooling-steam throughput. This is possible, in turn, due to the efficient utilization of the energy of the heated cooling steam, by the work-performing expansion of the latter in the separate steam turbine.

Additional compression energy, necessary in this respect, for the increased cooling-steam throughput is expediently generated thermally, in that the cooling steam is extracted from an already existing water/steam circuit, for example a steam turbine operated by fresh steam generated by heat exchange with exhaust gas from a gas turbine, in a combined gas and steam turbine plant or its waste-heat steam generator.

The heated cooling steam expanded in the steam turbine is then advantageously also supplied as low-temperature steam to this already existing water/steam circuit.

The separate fresh-steam heater or superheater usually necessary for the steam turbine is virtually implemented by turbine parts of the gas turbine which constitute the heat exchanger surfaces, in particular its steam-cooled turbine blades and/or turbine shaft. This allows particularly effective utilization of the exergy of the cooling steam, along with the same cooling action. The steam turbine may in this case be used directly for the mechanical drive of an air compressor of the gas turbine or of a feed water pump for the feed water supplied to a waste-heat steam generator or for current generation, for example for a secondary plant.

In a gas or steam turbine plant, in which the steam turbine operated by means of the heated cooling steam from the gas turbine is provided separately, the steam serving for cooling the separate steam turbine may be extracted from the waste-heat steam generator following the gas turbine on the exhaust-gas side or from the water/steam circuit of the further steam turbine of the gas and steam turbine plant.

Advantageously, the steam serving for cooling is extracted from the separate steam turbine itself and supplied to this once again. The steam serving for cooling expediently flows through both the moving blades and the guide vanes at least of the first moving-blade or guide-vane row of the separate steam turbine, as seen in the direction of the heated cooling steam flowing in as fresh steam.

Expediently, the steam serving for cooling is supplied to the moving blades of the separate steam turbine via its turbine shaft and at the same time opposite the inflow direction of the heated cooling steam, that is to say opposite the inflow direction of the fresh steam supplied to this steam turbine. The turbine shaft is in this case designed preferably as a hollow shaft and thus serves for cooling-steam conduction. The steam heated in the turbine shaft and in the blades is introduced within the separate steam turbine preferably in the working space of the latter. Introduction in this case takes place via the turbine blades, out of which the heated cooling steam emerges via blade orifices or blade bores into the working space. Alternatively, introduction takes place by recirculation, in that the steam serving for cooling is extracted from a pressure stage of the separate steam turbine having a low or medium steam pressure, as compared with the high steam pressure in the inlet region, and, after flowing through the turbine blades, is recirculated in these or into a comparatively even lower pressure region. The steam serving for cooling may also be led out of the separate steam turbine and supplied for further utilization.

As a result of steam cooling of this type, it is possible for the separate steam turbine to operate as a high-temperature turbine with a fresh-steam temperature of above 600° C., in particular of above 700° C. The steam serving for cooling, which preferably flows at least through the first guide-vane and/or moving-blade row and the associated casing walls and shaft walls, forms a cool protective layer on the corresponding blade or wall surfaces of the separate steam turbine. This ensures that the heated cooling steam from the gas turbine, serving as working medium or fresh steam, is not cooled or is cooled only insignificantly. As a result of the cooling of the separate steam turbine, the wall temperatures of its turbine casing and its turbine blades and also of its turbine shaft can be kept lower than, for example, 540° C. This makes it possible to use available and cost-effective standard materials even at a temperature of the heated cooling steam higher than 600° C. and with a high fresh-steam pressure of, for example, 120 bar.

In the case of a fresh-steam temperature of more than 700° C., it is expedient, particularly in the region of the first guide-vane and moving-blade row of the separate steam turbine, to provide the respective turbine parts with heat insulation layers.

By virtue of this high fresh-steam temperature, the efficiency of the turbine plant is also increased, as compared with conventional plant concepts. Thus, the steam cooling of the separate steam turbine operated by the heated cooling steam from the gas turbine has the considerable advantage, as compared with a steam-cooled gas turbine, that the cooling steam entering the working space of the separate steam turbines can itself be used as working medium and can be recirculated within the connected water/steam circuit. By virtue of the cooling of the separate steam turbine by means of steam, when conventional materials are used for the turbine casing and the turbine blades and also the turbine shaft, the fresh-steam temperature can be increased up to 800° C. and, consequently, the plant efficiency can be increased by 2 to 4 percentage points to 62% to 64%, as compared with the plant efficiency of 60% achieved hitherto.

As regards the turbine plant, the object is achieved, according to the invention, by means of the features of claim 10. Advantageous refinements are the subject matter of the subclaims referring back to this.

The advantages achieved by means of the invention are, in particular, that, by the use of heated cooling steam of a steam-cooled gas turbine as fresh steam for a likewise preferably steam-cooled steam turbine, a particularly high plant efficiency is achieved as a result of a particularly efficient utilization of the exergy or working capacity of the heated cooling steam. Since the gas turbine is utilized as a fresh-steam generator or superheater for such a separate high-temperature steam turbine, there is no need, as compared with a conventional steam turbine plant with a fossil-fired or solar-heated steam generator and as compared with a conventional combined gas or steam turbine plant, for the steam generator, but at least for the fresh-steam heater or superheater normally provided in a steam generator or steam boiler.

A further increase in plant efficiency is achieved in that the steam turbine operated by means of the heated cooling steam of the gas turbine is itself cooled by means of steam, for example from its water/steam circuit or preferably from the already existing steam turbine, and consequently the working capacity of the high-temperature steam can be utilized particularly effectively. Moreover, because of the intensified steam cooling, an increase in the throughput of cooling steam through the gas turbine and/or the increase in the cooling-steam temperature of the cooling steam used for the gas turbine makes it possible to increase the gas inlet temperature of the gas turbine.

By means of the method described, a fresh-steam temperature of the separate steam turbine of higher than 700° C. is possible, even in the case of a fresh-steam pressure restricted to lower than 40 bar. Even a heating of the cooling steam within the gas turbine to about 600° C. has an advantageous effect on plant efficiency on account of the effect mentioned.

Exemplary embodiments of the invention are explained in more detail below with reference to a drawing in which:

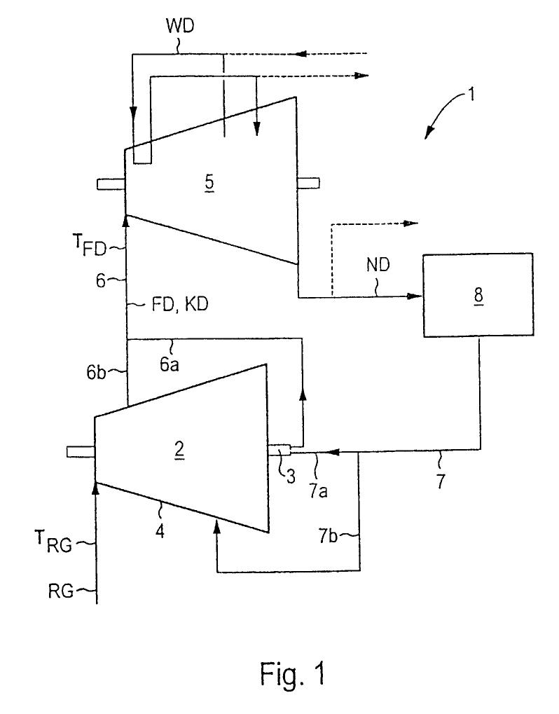

FIG. 1 shows diagrammatically a block diagram of a turbine plant with a steam-cooled gas turbine and with a high-temperature steam turbine operated by means of heated cooling steam,

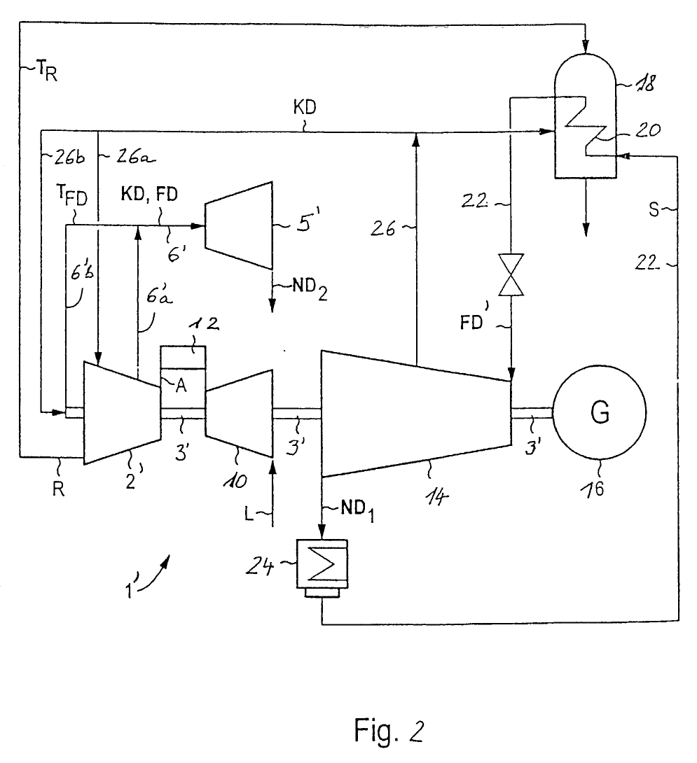

FIG. 2 shows diagrammatically a block diagram of a gas or steam turbine plant with a steam-cooled gas turbine and with a separate high-temperature steam turbine,

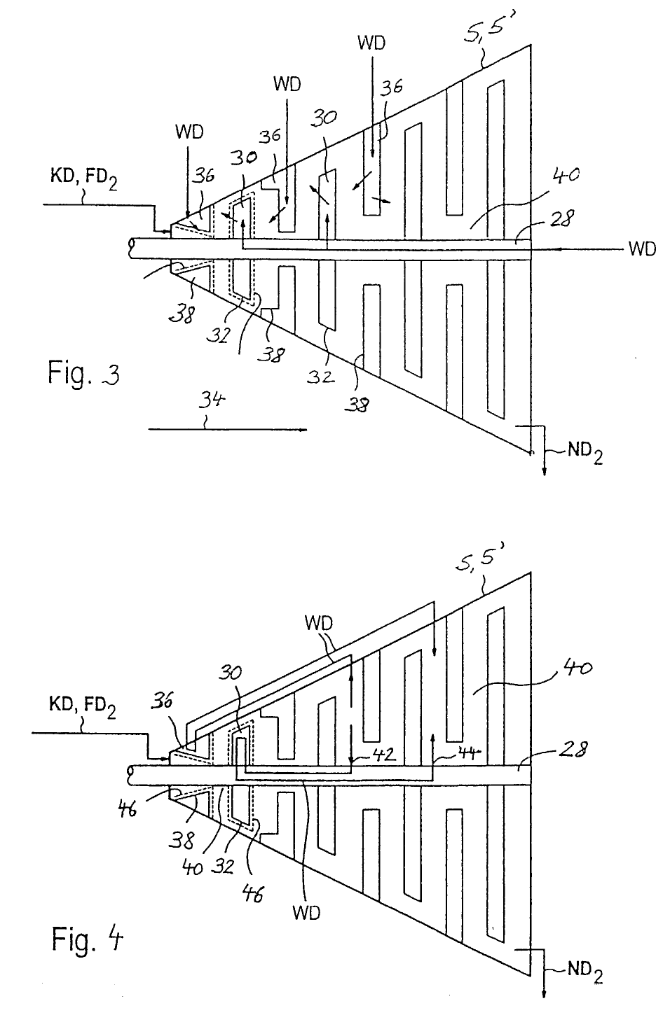

FIG. 3 shows diagrammatically a first variant of the steam-cooled high-temperature steam turbine according to FIGS. 1 and 2, and

FIG. 4 shows a second variant of the steam-cooled high-temperature steam turbine.

Parts corresponding to one another are given the same reference symbols in all the figures.

The turbine plant 1 according to FIG. 1 comprises a gas turbine 2, to which flue gas RG generated in a combustion chamber (not illustrated) is supplied as working medium on the inlet side. The gas turbine 2 is supplied, via its shaft 3 and via its turbine casing 4, with cooling steam KD which is utilized in a way not illustrated in any more detail, in particular, for cooling the turbine blades of the gas turbine 2 and at the same time is heated to a temperature of, for example, 600° C. to 800° C.

The cooling steam KD heated in the gas turbine 2 is supplied as fresh steam FD to a steam turbine 5. For this purpose, the steam turbine 5 is connected on the inlet side to the gas turbine 2 via a fresh-steam line 6 which is led via branch lines 6a, 6b to the turbine shafts 3 and via the latter to the moving blades or to the guide vanes of the gas turbine 2.

The cooling steam KD for the gas turbine 2 is supplied to the latter via a cooling-steam line 7 which issues via a first branch line 7a into the turbine shaft 3 and via the latter into moving blades and also via a second branch line 7b into the turbine casing 4 and via the latter into guide vanes of the gas turbine 2. The cooling steam KD is thus utilized for cooling the turbine blades and the turbine shaft 3 of the gas turbine 2 and also its turbine casing or casing parts, in particular in the inflow region of the hot flue gas RG, and at the same time is heated to a temperature of, for example, 600° C. to 800° C.

The cooling steam KD for the gas turbine 2 is expediently obtained at least partially from low-temperature steam ND expanded in the steam turbine 5, in that the latter is supplied to an already existing water/steam circuit 8 and is first condensed there in a way not illustrated in any more detail. The condensate pumped to the necessary cooling-steam pressure is subsequently evaporated by heat exchange, preferably with exhaust gas AG from the gas turbine 2, and the steam generated at the same time is heated to the desired cooling-steam temperature. The low-temperature steam ND may also be supplied at least partially for another use, for example as process steam.

The gas or steam turbine plant 1′ according to FIG. 2 comprises a gas turbine plant with a gas turbine 2′ having a coupled air compressor 10 and a combustion chamber 12 which precedes the gas turbine 2′ and in which fuel is burnt, with compressed air L being supplied to the working medium or fuel gas A for the gas turbine 2′. The gas turbine 2′ and the air compressor 10 and also a further steam turbine 14 and a generator 16 are seated on a common turbine shaft 3′. The gas and steam turbine plant 1′ is thus designed as a single-shaft plant in the exemplary embodiment.

The gas turbine 2′ is followed on the exhaust-gas side by a waste-heat steam generator or boiler 18, the heating surfaces 20 of which are connected into the water/steam circuit 22 of the further steam turbine 14 via a condenser 24 following the latter on the exhaust-steam side. The working medium A expanded in the gas turbine 2′ so as to perform work is supplied to the waste-heat steam generator 18 as flue gas or exhaust gas R.

The further steam turbine 14 is supplied with fresh steam FD′ generated in the waste-steam generator 18 by heat exchange with the flue gas R. The steam expanded so as to perform work, for example, in a high-pressure, medium-pressure and/or low-pressure stage of the further steam turbine 14 is supplied as low-temperature steam ND₁ to the condenser 24 and condenses there.

The condensate occurring in the condenser 24 is supplied once again as feed water S to the heating surfaces 20 of the waste-heat steam generator 18.

Steam is extracted from the further steam turbine 14 at a suitable point and is supplied as cooling steam KD to the gas turbine 2′. A part stream of the steam extracted from the further steam turbine 14 may also be recirculated into the waste-heat steam generator 18 and consequently into the water/steam circuit 22. This allows a particularly suitable setting of the quantity of cooling steam supplied to the gas turbine 2′ per unit time and therefore an effective control of the cooling-steam throughput through the gas turbine 2′.

For this purpose, the gas turbine 2′ is connected to the further steam turbine 14 via a cooling-steam line 26 which issues via a first branch line 26a into guide vanes (not illustrated) and casing parts and also via a second branch line 26b into the turbine shaft 3′ and into moving blades of the gas turbine 2′. The cooling steam KD is thus utilized for cooling the turbine blades and the turbine shaft 3′ of the gas turbine 2′ and its casing parts, in particular in the inflow region of the hot fuel gas or working medium A, and at the same time is heated to a temperature of, for example, 600° C. to 800° C.

The cooling steam KD heated in the gas turbine 2′ is supplied as fresh steam FD to the separate steam turbine 5′. For this purpose, the separate steam turbine 5′ is connected on the inlet side to the gas turbine 2′ via a fresh-steam line 6′ which is led via branch lines 6′a, 6′b to the guide vanes and to the turbine shaft 3′. The low-temperature steam ND₂ expanded in the separate steam turbine 5′ is supplied to the condenser 24 or for another use, for example as process steam.

The steam turbine 5, 5′ is designed for the temperature and the pressure of the fresh steam FD, that is to say of the heated cooling steam KD from the gas turbine 2, 2′.

Its working capacity is thereby utilized particularly effectively, so that a particularly high efficiency of the turbine plant 1, 1′ is achieved. The fresh-steam temperature TF_{D} of the heated cooling steam KD and consequently of the fresh steam F_{D} is preferably 600° C. to 700° C. The steam turbine 5, 5′ thus works as a high-temperature steam turbine.

Since the working-medium temperature TR_{G} of the fuel gas or flue gas RG supplied to the gas turbine 2, 2′ is usually above 1200° C., the cooling steam KD can also be heated to a fresh-steam temperature TF_{D} of higher than 700° C., in that, in particular, the turbine blades of the gas turbine 2, 2′ are utilized virtually as a fresh-steam heater. By virtue of the effective utilization of the heated cooling steam KD, FD, the cooling-steam throughput through the gas turbine 2, 2′ can also be increased correspondingly, thus, in turn, raising the cooling effect, while at the same increasing the exergy of the cooling steam KD.

To control such high fresh-steam temperatures TFD, with T_{FD}>600° C., the steam turbine 5, 5′ is itself likewise cooled preferably by means of steam WD. This is clearly illustrated comparatively by means of the variants in FIGS. 3 and 4. The steam WD serving for cooling is expediently extracted from the steam turbine 5 itself at a suitable point (FIG. 1). The steam WD may also be extracted from the further steam turbine 14 or from the waste-heat steam generator 18 and consequently, at a suitable point, from the water/steam circuit 22 of the further steam turbine 14 according to the exemplary embodiment shown in FIG. 2.

As illustrated diagrammatically in FIG. 3, the steam WD serving for cooling is supplied, on the one hand, to a turbine shaft 28 and via the latter to the moving blades 30 at least of the first moving-blade rows 32.

In the exemplary embodiment, the steam WD serving for cooling is also supplied to the second moving-blade rows 32, as seen in the inflow direction 34 of the fresh steam KD, FD supplied to the steam turbine 5, 5′.

In this case, the steam WD is supplied to the turbine shaft 28 designed as a hollow shaft preferably opposite to the inflow direction 34 of the heated cooling steam KD and consequently of the fresh steam FD. The steam WD serving for cooling is thus heated along the fresh steam FD which expands within the steam turbine 5, 5′ in the inflow direction 34 and is increasingly cooled.

Expediently, steam WD is also supplied to the guide vanes 36 of the first guide-vane row 38 for the cooling of these. In the exemplary embodiment, in addition, the guide vanes 36 of the second and third guide-vane rows 38 of the steam turbine 5, 5′ are also cooled by steam WD.

The steam WD flowing through the turbine shaft 28 and the moving blades 30 and also the guide vanes 36 is introduced into the working space 40 of the steam turbine 5, 5′. The steam WD is mixed there with the expanded fresh steam FD and, together with the latter, leaves the steam turbine 5, 5′ as low-temperature steam ND.

In the version according to FIG. 4, the steam WD serving for cooling is extracted from the steam turbine 5, 5′ out of the medium-pressure or low-pressure region p_{M} or p_{N} of the latter and is led into the moving blades 30 at least of the first moving-blade row 32 which are arranged in the high-pressure region p_{H} of the steam turbine 5, 5′. For this purpose, in the exemplary embodiment, an inlet orifice 42 is provided in the turbine shaft 28 in the medium-pressure region p_{M}, via which inlet orifice the steam WD of medium or low pressure enters the turbine shaft 28 and flows via the latter into the moving blade 30. The heated steam WD flows out of these via the turbine shaft 28 and, via an outlet orifice 44 which is provided in this and in the exemplary embodiment lies in the low-pressure region p_{N}, back into the working space 40 of the steam turbine 5, 5′. The flow of the steam WD is generated by the pressure difference, that is to say by the pressure drop or the pressure gradient, between the medium-pressure region p_{M} and the low-pressure region p_{N} with a comparatively low steam pressure.

Correspondingly, in this second variant, the guide vanes 36 at least of the first guide-vane row 38 of the steam turbine 5, 5′ are also cooled by the recirculation of steam WD extracted from the medium-pressure region p_{M} and, after flowing through the guide vanes 36, led into the low-pressure region p_{N}. Also, in both variants, steam WD serving for cooling can be led along the casing wall of the steam turbine 5, 5′ in a way not illustrated in any more detail. Moreover, in both variants, the guide vanes and moving blades 36, 30 of at least the first guide-vane or moving-blade row 38, 32 are expediently provided with a heat protection or heat insulation layer 46.

Also, in both variants, steam WD serving for cooling may be routed along the casing wall of the steam turbine 5, 5′ in a way not illustrated in any more detail, while the casing wall may likewise be provided with a heat insulation layer.

1. A method for operating a steam turbine (5, 5′), in which steam (FD) is expanded so as to perform work, the steam (FD) being generated in a gas turbine (2, 2′) by the heating of cooling steam (KD) supplied to the latter, characterized in that the steam turbine (5, 5′) is operated with cooling steam (KD) from the gas turbine (2, 2′), said cooling steam being heated to a fresh-steam temperature (TFD) higher than 600° C., and in that the steam turbine (5, 5′) is cooled by means of steam (WD).

2. The method as claimed in claim 1, characterized in that the steam (WD) serving for cooling is extracted from the steam turbine (5) itself.

3. The method as claimed in claim 1 or 2, characterized in that the steam (WD) serving for cooling is supplied to a number of moving blades (30) and guide vanes (36) and flows through these, the steam (WD) being supplied to the moving blades (30) of the steam turbine (5, 5′) via the turbine shaft (28) of the latter.

4. The method as claimed in claim 3, characterized in that the steam (WD) heated in the turbine blades (30, 36) emerges from these and is introduced within the steam turbine (5, 5′) into the working space (40) of the latter.

5. The method as claimed in claim 3 or 4, characterized in that the moving blades and/or guide vanes (30, 36) of at least the first blade row (32 of 38) are cooled by the recirculation of steam (WD) extracted in a medium-pressure region (p_{M}) of the steam turbine (5, 5′) and, after flowing through the moving blades or guide vanes (30, 36), introduced into a low-pressure region (p_{N}).

6. The method as claimed in one of claims 1 to 5, characterized in that the cooling steam (KD) for the gas turbine (2, 2′) is generated at least partially by low-temperature steam (ND) extracted from the steam turbine (5).

7. The method as claimed in one of claims 1 to 5, characterized in that the cooling steam (KD) is extracted from a waste-heat steam generator (18) following the gas turbine (2′) on the exhaust-gas side.

8. The method as claimed in claim 7, characterized in that the steam (WD) serving for cooling is extracted from the waste-heat steam generator (18).

9. The method as claimed in claim 7 or 8, characterized in that the cooling steam (KD) and/or the steam (WD) serving for cooling is extracted from a further steam turbine (14) operated by steam (FD) from the waste-heat steam generator (18).

10. A turbine plant with a steam-cooled steam turbine (5, 5′) working according to the method as claimed in one of claims 1 to 9 and with a steam-cooled gas turbine (2, 2′), the steam turbine (5, 5′) being connected on the inlet side to the gas turbine (2, 2′) via a fresh-steam line (6, 6′), via which the heated cooling steam (KD) from the gas turbine (2, 2′) is supplied as fresh steam (FD) to the steam turbine (5, 5′).

11. The turbine plant as claimed in claim 10, characterized in that the gas turbine (2, 2′) is connected to the steam turbine (5, 5′) via a cooling-steam line (7, 26), via which cooling steam (KD) extracted from the steam turbine (5, 5′) is supplied to the gas turbine (2, 2′).

12. The turbine plant as claimed in claim 10, with a waste-heat steam generator (18) which follows the gas turbine (2′) on the exhaust-gas side and the heating surfaces (20) of which are connected into the water/steam circuit (22) of a further steam turbine (5′).

13. The turbine plant as claimed in claim 12, characterized in that the gas turbine (2′) is connected to the further steam turbine (14) via a cooling-steam line (26), via which cooling steam (KD) extracted from the further steam turbine (5′) can be supplied to the gas turbine (2′).
